(19) United States
(12) Patent Application Publication
(10) Pub. No.: US 2025/0113194 A1
(43) Pub. Date: Apr. 3, 2025

(54) Rogue Station Handling in Ranging

(71) Applicant: Apple Inc., Cupertino, CA (US)

(72) Inventor: Srinivas BURUGUPALLI, Belmont, CA (US)

(21) Appl. No.: 18/886,183

(22) Filed: Sep. 16, 2024

Related U.S. Application Data
(60) Provisional application No. 63/586,474, filed on Sep. 29, 2023.

(51) Int. Cl. H04W 12/122; H04B 17/318; H04W 48/20; H04W 64/00

(52) U.S. Cl. CPC H04W 12/122; H04B 17/318; H04W 48/20; H04W 64/003

(57) ABSTRACT

An apparatus configured to determine an occurrence of a timing clock attack from a rogue responding station (R-rSTA) when performing a ranging operation, initiate a selection procedure to select two responding stations (rSTAs) from a plurality of rSTAs in addition to the R-rSTA, wherein the selected two rSTAs have lower received signal strength indicators (RSSI) values compared to other rSTAs of the plurality of rSTAs and perform the ranging operation using the R-rSTA and the selected two rSTAs to determine a position of the apparatus.

This application claims priority to U.S. Provisional Application Ser. No. 63/586,474 filed on Sep. 29, 2023, entitled “Rogue Station Handling in Ranging,” the entirety of which is incorporated by reference herein.

### BACKGROUND

Ranging may be used to locate a position of a mobile communications device (MCD). Ranging may be performed by an MCD measuring the travel time or signal strength of radio signals exchanged with three or more stations, e.g., Wi-Fi access points (APs). Generally, increased numbers of APs increase determined location accuracy, as the MCD may triangulate its location against different groupings of APs.

In some scenarios, a malicious actor may utilize a rogue AP to cause ranging measurements to inaccurately vary. Rogue APs may also be caused by timing or signaling errors (e.g., pathloss, obstructions, etc.) in some instances and need not always be caused by a malicious actor. This is unacceptable in certain scenarios where location accuracy is crucial, such as during an emergency call at a crowded stadium. Location inaccuracy in these scenarios may waste critical rescuer time searching locations that the user/MCD are not present. Mitigating rogue AP ranging errors is an ongoing concern in the field.

### SUMMARY

Some example embodiments are related to an apparatus having processing circuitry configured to determine an occurrence of a timing clock attack from a rogue responding station (R-rSTA) when performing a ranging operation, initiate a selection procedure to select two responding stations (rSTAs) from a plurality of rSTAs in addition to the R-rSTA, wherein the selected two rSTAs have lower received signal strength indicators (RSSI) values compared to other rSTAs of the plurality of rSTAs and perform the ranging operation using the R-rSTA and the selected two rSTAs to determine a position of the apparatus.

Other example embodiments are related to a method for determining an occurrence of a timing clock attack from a rogue responding station (R-rSTA) when performing a ranging operation, initiating a selection procedure to select two responding stations (rSTAs) from a plurality of rSTAs in addition to the R-rSTA, wherein the selected two rSTAs have lower received signal strength indicators (RSSI) values compared to other rSTAs of the plurality of rSTAs and performing the ranging operation using the R-rSTA and the selected two rSTAs to determine a position of a device performing the method.

### BRIEF DESCRIPTION OF THE DRAWINGS

FIG. 1 shows an example network arrangement according to various example embodiments.

FIG. 2 shows an example MCD according to various example embodiments.

FIG. 3 shows a ranging diagram according to various example embodiments.

FIG. 4 shows a method according to various example embodiments.

### DETAILED DESCRIPTION

The example embodiments may be further understood with reference to the following description and the related appended drawings, wherein like elements are provided with the same reference numerals. The example embodiments relate to improved handling of ranging location calculations for MCDs communicating with rogue responding stations.

The example embodiments are described with regard to a mobile communications device (MCD). However, reference to an MCD is merely provided for illustrative purposes. The example embodiments may be utilized with any electronic component that may establish a connection to a network and is configured with the hardware, software, and/or firmware to exchange information and data with the network. Therefore, the MCD as described herein is used to represent any electronic component.

A malicious actor may utilize various actions (e.g., a clock attack) to affect a ranging operation performed by an MCD. The precise mechanics of a clock attack are beyond the scope of the present disclosure, but one of skill in the art will recognize that such clock attacks may result in ranging errors of tens of meters. Errors that are mild hindrances when personally navigating become unacceptable in various situations, e.g., emergency situations. An emergency caller in a crowded location (e.g., a stadium, airport, festival, hospital, etc.) may have their location reported to emergency responders as being tens of meters from their true location. This error may lead first responders to an entirely different floor/level/section of the building/venue. This is dangerous when time is of the essence.

Some implementations may cause MCDs to discard ranging errors if the MCD detects a certain clock error. For example, a clock error may be 50 parts-per-million (ppm). However, in some cases, it may still be prudent to calculate a location even if there is a rogue AP by attempting to minimize the error caused by the rogue AP.

Existing implementations will add a rogue responding AP (R-rAP) to a denylist and the MCD will attempt ranging with other responding AP (rAPs). However, if the number of rAPs is limited (i.e., less than three) or in the event that there is more than one R-rAP, there is no mechanism to reliably complete ranging operations. Returning to the above-mentioned emergency scenarios, a moderately inaccurate reported position (on the order of tens of meters or less) may be preferable to reporting no location at all to first responders.

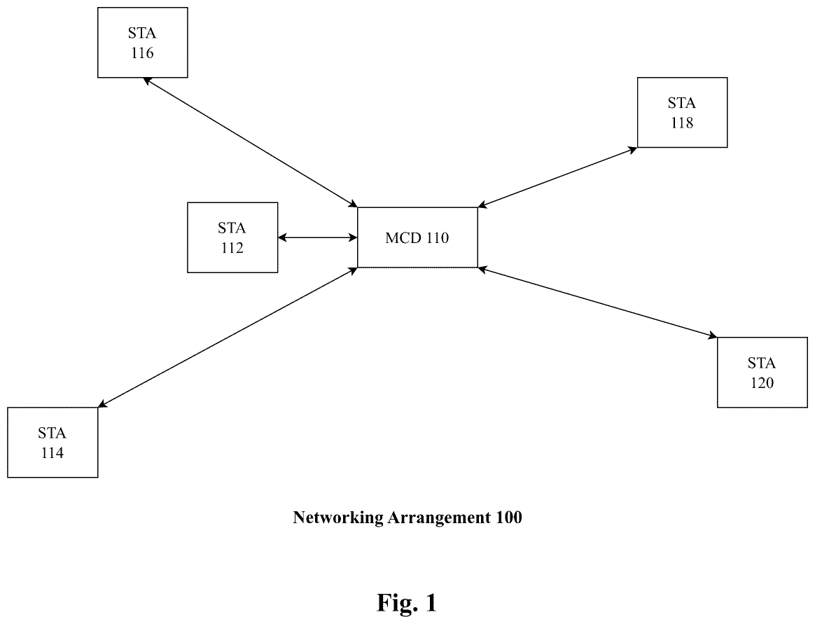

FIG. 1 shows a networking arrangement 100 according to various example embodiments. The networking arrangement 100 shows an MCD 110. The MCD 110 may be any type of electronic component that is configured to communicate via a network, e.g., mobile phones, tablet computers, desktop computers, smartphones, phablets, embedded devices, wearables, Internet of Things (IoT) devices, etc.

The networking arrangement 100 shows several stations (“STAs”) 112, 114, 116, 118, and 120. The STAs 112-120 may be any device that is configured to communicate via a network, e.g., mobile phones, tablet computers, desktop computers, smartphones, phablets, embedded devices, wearables, Internet of Things (IoT) devices, etc. Throughout the example embodiments, STAs are described as Access Points (APs), though this is only an example and the STAs may be any type of STA.

In the example of FIG. 1, the STAs 112, 114, 116, 118, and 120 may form part of a wireless network such as a Wi-Fi network. The example embodiments will be described with reference to the MCD 110 performing ranging operations using the devices of a Wi-Fi network, e.g., STAs 112, 114, 116, 118, and 120. This is only an example as the MCD 110 may perform ranging operations with devices of other types of networks including but not limited to public/private cellular networks, Bluetooth networks, Zigbee networks, etc.

The MCD 110 may perform ranging operations with the STAs 112-120. Ranging operations are typically independent from active communications between the MCD 110 and any individual STA of the STAs 112-120. The STAs 112-120 may each have individual signal strengths and be located at various distances from the MCD 110.

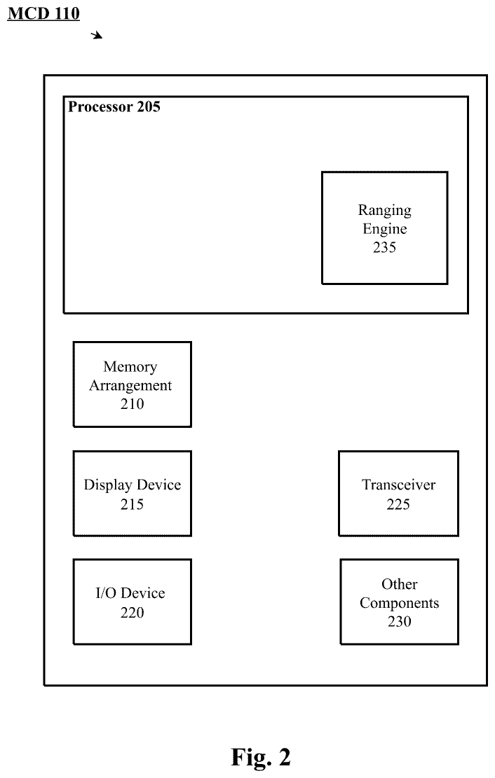

FIG. 2 shows an example mobile communications device (MCD) 110 according to various example embodiments. The MCD 110 may be any type of electronic component that is configured to communicate via a network, e.g., mobile phones, tablet computers, smartphones, embedded devices, wearables, Internet of Things (IoT) devices, etc. The MCD 110 may communicate with devices of one or more wireless networks, e.g., Wi-Fi network STAs 112, 114, 116, 118, and 120 as shown in the FIG. 1. The MCD 110 may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device (such as a camera), ports to electrically connect the MCD 110 to other electronic devices, sensors to detect conditions of the MCD 110, etc.

The processor 205 may be configured to execute a plurality of engines for the MCD 110. For example, the engines may include a ranging engine 235 for performing operations related to improved MCD handling of rogue responding station (R-rSTAs) for ranging operations.

The above referenced engine being an application (e.g., a program) executed by the processor 205 is only an example. The functionality associated with the engines may also be represented as a separate incorporated component of the MCD 110 or may be a modular component coupled to the MCD 110, e.g., an integrated circuit with or without firmware. For example, the integrated circuit may include input circuitry to receive signals and processing circuitry to process the signals and other information. The engines may also be embodied as one application or separate applications. In addition, in some MCDs, the functionality described for the processor 205 is split among two or more processors such as a baseband processor and an applications processor. The example embodiments may be implemented in any of these or other configurations of an MCD.

The memory arrangement 210 may be a hardware component configured to store data related to operations performed by the MCD 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with one or more wireless networks such as local area networks (WLANs), Wi-Fi networks, etc. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

The example embodiments provide operations and logic for error reduction for R-rAPs during the MCD 110 ranging calculations. The example embodiments may be performed for ranging calculations with one R-rAP out of three identified rAPs (e.g., two “clean” rAPs), and the two clean rAPs are approximately equidistant to one another. However, the example embodiments do not require that the two clean rAPs be approximately equidistant to one another. The example embodiments may be performed for ranging calculations with various pluralities of rAPs.

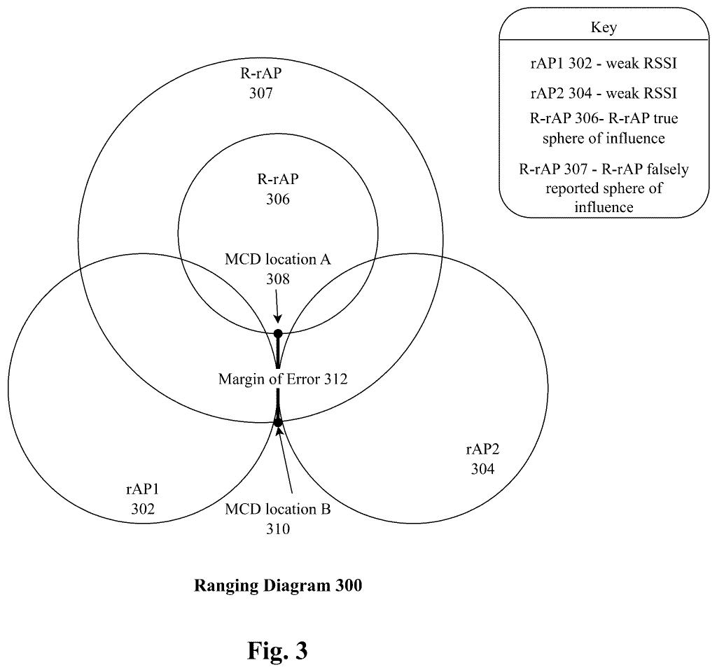

In such a scenario, the MCD 110 may select the two clean rAPs (or the two rAPs with the lowest possible received signal strength indicators (RSSIs)) if there are more than two typically functioning rAPs in range of the MCD 110). Selection of two rAPs with the lowest possible RSSI values may indicate that the clean rAPs overlap to the minimum possible extent, which may allow for a reduction in a margin of error. In some example embodiments, the selected RSSI may be the lowest detectable level of signals, e.g., less than −80 dBm. This selection and minimization of the ranging error will be described with reference to FIG. 3.

FIG. 3 shows a ranging diagram 300 according to various example embodiments. The ranging diagram 300 shows an rAP1 302, an rAP2 304, an R-rAP 306, and an R-rAP 307. The R-rAP 306 may be the true sphere range of an R-rAP and the R-rAP 307 may be the falsely reported sphere range to the MCD 110 (e.g., via a timing attack and/or R-rAP errors). The rAP1 302 and the rAP2 304 may be normally functioning (e.g., clean) APs.

An MCD (e.g., the MCD 110) may operate within the range (e.g., spherical coverage areas) of the rAP1 302, the rAP2, and the R-rAPs 306-307. According to the example embodiments, the MCD 110 may recognize that the R-rAP associated with the R-rAP 306 and the R-rAP 307 is rogue, e.g., the R-rAP 306 and/or R-rAP 307 is a false ranging measurement. The MCD 110 may understand that the R-rAP 306 and the R-rAP 307 are rogue based on, for example, receiving inconsistent measurements from the R-rAP 306 and the R-rAP 307 whether through a timing attack or error. In such a scenario, the MCD 110 may select two clean APs (e.g., the rAP1 302 and rAP2 304) with the lowest possible RSSI values as measured at the MCD 110. Referring back to FIG. 1, the two APs that have the lowest RSSI value may be the two APs that are located the farthest from the MCD 110, e.g., STAs 114 and 116. However, distance is not the only determining factor in RSSI strength and this is only used as an example of selecting two clean APs. For example, another factor in RSSI strength may be whether the MCD 110 is in a line of sight (LoS) with the AP or non-LoS with the AP.

Returning to FIG. 3, performing ranging calculations with the rAP1 302, the rAP2 304 and the r-AP 306 may result in the determined location being MCD location A 308. Performing ranging calculations with the rAP1 302, the rAP2 304 and the r-AP 307 may result in the determined location being MCD location B 310. The distance between the MCD location A 308 and the MCD location B 310 is a margin of error 312.

This selection of the clean rAPs with the lowest possible RSSI values ensures that the clean rAPs 302 and 304 overlap to the minimum extent possible, thereby reducing the margin of error 312 between the potential location A 308 and location B 310 of the MCD 110.

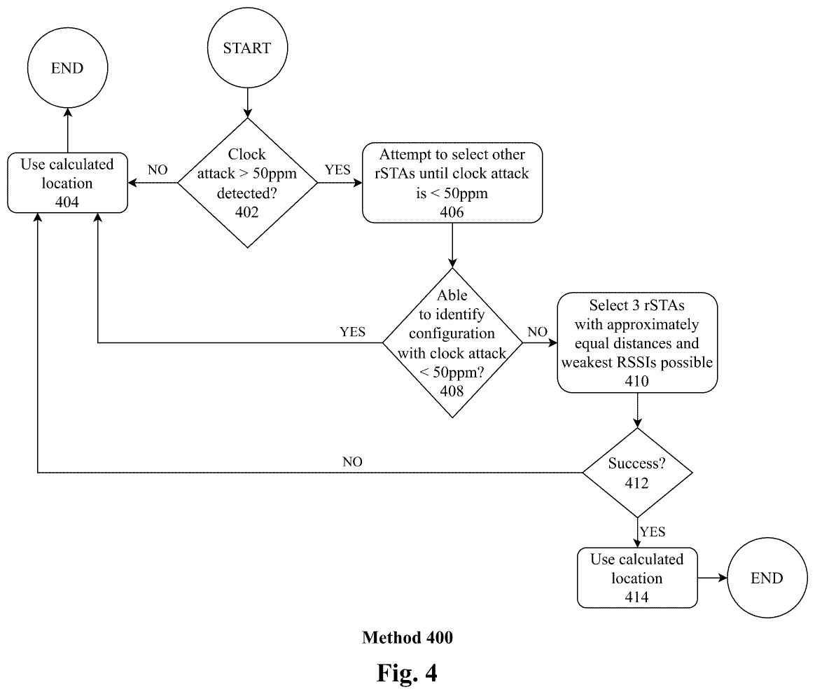

FIG. 4 shows a method 400 according to various example embodiments. The method 400 may be performed by an MCD, such as the MCD 110.

In 402, the MCD 110 determines whether a clock attack greater than 50 ppm has been detected, e.g., do measurements from one of the APs being used for ranging vary by more than 50 ppm. It should be noted here that clock attack may also encompass errors introduced by an AP and that a malicious actor need not be the cause of a rogue AP. Furthermore, while the example embodiments use a clock error of 50 ppm to determine if there is a rogue AP, this is only an example and the MCD 110 may be configured to use any value of clock error to determine if there is a rogue AP. For example, for applications that require greater location accuracy, the error threshold may be set to a value lower than 50 ppm and for applications that have relaxed location accuracy, the error threshold may be set to a value greater than 50 ppm.

If the MCD 110 does not determine that a clock attack greater than 50 ppm has occurred, the MCD 110 proceeds to 404 and uses its calculated location via ranging.

If the MCD 110 does determine that a clock attack greater than 50 ppm has occurred, the method proceeds to 406 where the MCD 110 attempts to select other rSTAs (e.g., rAPs) until the clock attack is less than 50 ppm. For example, referring to FIG. 1, the MCD 110 may select various combinations of the STAs 112, 114, 116, 118, and 120 to determine if any of the combinations result in measurements with less than a 50 ppm variation.

In 408, the MCD 110 determines whether it has identified any configuration of rSTAs that reduce the clock attack to less than 50 ppm.

If the MCD 110 has identified any configurations of rSTAs that reduce the clock attack to less than 50 ppm, the method proceeds to 404 and uses the calculated location via ranging based on the selected combination of APs.

If the MCD 110 has not identified any configurations of rSTAs that reduce the clock attack to less than 50 ppm, the method proceeds to 410 where the MCD selects three rSTAs with approximately equal distances and with the weakest possible RSSIs possible. In some example embodiments, the MCD 110 may instead select two clean rSTAs in addition to a rogue rSTA.

In 412, the MCD 110 determines whether the selection operation 410 was successful. If the operation 410 was successful, the method proceeds to 414 where the MCD 110 uses the calculated position via ranging with the selected rSTAs from 410.

If the operation 410 was not successful, the MCD 110 proceeds to 404 and may use the calculated position via ranging with the originally selected rSTAs. In some example embodiments, the MCD may disregard the ranging measurements and not provide a location because the margin of error is too large.

Thus, the example embodiments provide a manner for an MCD to reduce the margin of error in location measurements when one of the STAs used for ranging is a rogue STA. As described above, in some examples, a moderately inaccurate reported position (on the order of tens of meters or less) may be preferable to reporting no location at all. Thus, the example embodiments may be implemented on an application basis, e.g., those applications that prefer the moderately inaccurate reported position as opposed to no position at all. Examples of such applications or scenarios may include emergency applications, navigation applications used for indoors or tightly spaced areas, etc., where it is better to have a location estimate of a few meters inaccuracy rather than not have it at all.

### EXAMPLES

In a first example, a method, comprising determining an occurrence of a timing clock attack from a rogue responding station (R-rSTA) when performing a ranging operation, initiating a selection procedure to select two responding stations (rSTAs) from a plurality of rSTAs in addition to the R-rSTA, wherein the selected two rSTAs have lower received signal strength indicators (RSSI) values compared to other rSTAs of the plurality of rSTAs and performing the ranging operation using the R-rSTA and the selected two rSTAs to determine a position of the apparatus.

In a second example, the method of the first example, wherein the selected two rSTAs have a two lowest RSSI values compared to other rSTAs of the plurality of rSTAs.

In a third example, the method of the second example, wherein the two lowest RSSI values are less than −80 dBm.

In a fourth example, the method of the first example, wherein the selected two rSTAs are less than a predefined distance threshold from one another or from the apparatus.

In a fifth example, the method of the fourth example, wherein the predefined distance threshold is based on whether the two rSTAs have a line-of-sight (LoS) to each other or a mobile communication device (MCD) comprising the apparatus has a LoS to one or both of the two rSTAs.

In a sixth example, the method of the first example, wherein the timing clock attack is determined based on measurements on signals received from the R-rSTA varying more than a predetermined threshold.

In a seventh example, the method of the sixth example, wherein the predetermined threshold is greater than 50 parts per million (ppm).

In an eighth example, the method of the first example, further comprising preparing the position to be transmitted to an emergency service or a predefined trusted contact.

In a ninth example, the method of the first example, further comprising determining that an installed application or service from a predefined list of applications and services has requested a user location.

In a tenth example, the method of the ninth example, wherein the list of applications comprises an emergency application or a navigation application.

In an eleventh example, the method of the first example, wherein the R-rSTA and the selected two rSTAs comprise access points (APs) of a Wi-Fi network.

In a twelfth example, a processor configured to perform any of the methods of the first through eleventh examples.

In a thirteenth example, a mobile communication device configured to perform any of the methods of the first through eleventh examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments of the above-described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

As described above, one aspect of the present technology is the gathering and use of data available from specific and legitimate sources to improve the delivery to users of invitational content or any other content that may be of interest to them. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising processing circuitry configured to:
determine an occurrence of a timing clock attack from a rogue responding station (R-rSTA) when performing a ranging operation;
initiate a selection procedure to select two responding stations (rSTAs) from a plurality of rSTAs in addition to the R-rSTA, wherein the selected two rSTAs have lower received signal strength indicators (RSSI) values compared to other rSTAs of the plurality of rSTAs; and
perform the ranging operation using the R-rSTA and the selected two rSTAs to determine a position of the apparatus.

2. The apparatus of claim 1, wherein the selected two rSTAs have a two lowest RSSI values compared to other rSTAs of the plurality of rSTAs.

3. The apparatus of claim 2, wherein the two lowest RSSI values are less than −80 dBm.

4. The apparatus of claim 1, wherein the selected two rSTAs are less than a predefined distance threshold from one another or from the apparatus.

5. The apparatus of claim 4, wherein the predefined distance threshold is based on whether the two rSTAs have a line-of-sight (LoS) to each other or a mobile communication device (MCD) comprising the apparatus has a LoS to one or both of the two rSTAs.

6. The apparatus of claim 1, wherein the timing clock attack is determined based on measurements on signals received from the R-rSTA varying more than a predetermined threshold.

7. The apparatus of claim 6, wherein the predetermined threshold is greater than 50 parts per million (ppm).

8. The apparatus of claim 1, wherein the processing circuitry is further configured to:
prepare the position to be transmitted to an emergency service or a predefined trusted contact.

9. The apparatus of claim 1, wherein the processing circuitry is further configured to:
determine that an installed application or service from a predefined list of applications and services has requested a user location.

10. The apparatus of claim 9, wherein the list of applications comprises an emergency application or a navigation application.

11. The apparatus of claim 1, wherein the R-rSTA and the selected two rSTAs comprise access points (APs) of a Wi-Fi network.

12. A method, comprising:
determining an occurrence of a timing clock attack from a rogue responding station (R-rSTA) when performing a ranging operation;
initiating a selection procedure to select two responding stations (rSTAs) from a plurality of rSTAs in addition to the R-rSTA, wherein the selected two rSTAs have lower received signal strength indicators (RSSI) values compared to other rSTAs of the plurality of rSTAs; and
performing the ranging operation using the R-rSTA and the selected two rSTAs to determine a position of a device performing the method.

13. The method of claim 12, wherein the selected two rSTAs have a two lowest RSSI values compared to other rSTAs of the plurality of rSTAs.

14. The method of claim 12, wherein the selected two rSTAs are less than a predefined distance threshold from one another or from the apparatus.

15. The method of claim 14, wherein the predefined distance threshold is based on whether the two rSTAs have a line-of-sight (LoS) to each other or a mobile communication device (MCD) performing the method has a LoS to one or both of the two rSTAs.

16. The method of claim 12, wherein the timing clock attack is determined based on measurements on signals received from the R-rSTA varying more than a predetermined threshold.

17. The method of claim 12, further comprising:
preparing the position to be transmitted to an emergency service or a predefined trusted contact.

18. The method of claim 12, further comprising:
determining that an installed application or service from a predefined list of applications and services has requested a user location.

19. The method of claim 18, wherein the list of applications comprises an emergency application or a navigation application.

20. The method of claim 12, wherein the R-rSTA and the selected two rSTAs comprise access points (APs) of a Wi-Fi network.
